(19) United States
(12) Patent Application Publication
(10) Pub. No.: US 2003/0020354 A1
(43) Pub. Date: Jan. 30, 2003

(54) Electrical machine

(76) Inventors: Falko Abel, Regensburg (DE); Rainer Munzner, Schwarzenberg (DE); Holger Pertermann, Dresden (DE)

Correspondence Address: LERNER AND GREENBERG, P.A., Post Office Box 2480, Hollywood, FL, 33022-2480, US

(21) Appl. No.: 10/186,598

(22) Filed: Jul. 1, 2002

Related U.S. Application Data
(63) Continuation of application No. PCT/EP00/11264, filed on Nov. 14, 2000.

(30) Foreign Application Priority Data
Dec. 29, 1999 (DE) 199 63 704.0

(51) Int. Cl. H02K 3/48

(52) U.S. Cl. 310/214

(57) ABSTRACT

A laminate core of a stator of an electrical machine with an internal rotor includes slots each having a slit opening dimensioned such that only a single winding wire can be inserted therethrough into the slot.

### CROSS-REFERENCE TO RELATED APPLICATION

This application is a continuation of copending International Application No. PCT/EP00/11264, filed Nov. 14, 2000, which designated the United States and was not published in English.

### BACKGROUND OF THE INVENTION

1. Field of the Invention

The invention relates to an electrical machine having an internal rotor and having a laminated stator core that surrounds the internal rotor, is fitted with at least one winding and has slots that face the internal rotor and through which a winding wire is passed a number of times.

An electrical machine is disclosed in German Published, Non-Prosecuted Patent Application DE 40 37 753 A1, corresponding to U.S. Pat. No. 5,204,566 to Borgen et al. Such a machine is used, for example, as an internal rotor motor for driving a washing machine. In such a case, the electrical machine has a laminated core that is formed from a large number of laminates in layers one above the other. The laminated core has a central circular opening in which an internal rotor rotates. The internal rotor is, for example, in the form of a squirrel cage rotor. Slots pointing toward the center of the opening are disposed around the central opening, are each lined with an insulating layer, and are used to hold windings that are formed from varnished wire. To allow the slots to be wound easily, each slot has an opening that points toward the center and into which an insertion tool of a winding machine is inserted into the slot before windings, which are mushroomed upward to form coils, of the winding wire, that is to say, of the varnished wire.

### SUMMARY OF THE INVENTION

It is accordingly an object of the invention to provide an electrical machine that overcomes the hereinafore-mentioned disadvantages of the heretofore-known devices of this general type and that produces less noise while, at the same time, is easier to manufacture.

With the foregoing and other objects in view, there is provided, in accordance with the invention, an electrical machine, including an internal rotor, a laminated core surrounding the internal rotor, the core having at least one winding wire forming a winding, the winding wire having a diameter, the core defining slots facing the internal rotor and through which the winding wire is passed a number of times, the slots each having a slot slit opening, and the slot slit opening facing the internal rotor and having an unobstructed width greater than the diameter of the winding wire but less than twice the diameter of the winding wire.

For an electrical machine of the type mentioned initially, the slots each have an opening that faces the internal rotor and whose unobstructed width is less than twice the diameter of the winding wire but is greater than the diameter of the winding wire.

Modern winding techniques have made it possible to no longer insert just a number of winding wires, that is to say, for example, two winding wires, through the opening into the slot at the same time, but to insert only a single winding wire in each case. This allows the slot opening that is required to be reduced to a minimum, which is governed by the diameter of the varnished wire, the width of the sealing lips that are used and are used as an insertion aid and are part of the insertion tool, as well as the safety separations between the varnished wire and the sealing lips, together with the tolerances. Taking account of all these circumstances, it is now possible according to the invention to reduce the width of the opening such that it is only slightly wider than the diameter of the varnished wire, in which case, of course, additional space must be provided for the sealing lips. Because the invention makes it possible for the stator slot opening to be smaller, less noise is produced when the rotor revolves, and a better magnetic flux is produced, which flows over a greater length through the iron of the laminated core and has a narrower air gap to overcome. Such characteristics result in greater electromagnetic efficiency.

In addition, the insertion of individual winding wires into the slot makes it possible to achieve a higher slot filling factor. The slot filling factor describes the ratio of the total area of the windings-in a slot with respect to the slot area reduced by the slot insulation area. An insulation layer that insulates the wall of the slot from the laminated core forms the slot insulation area. The total area of the windings is calculated from the number of conductive wire cross-sections, that is to say, the cores of the varnished wire, multiplied by the rectangular area covered by the insulated varnished wire. Due to the smaller slot opening and the individual wire insertion that is, thus, possible, a slot filling factor of at least 75% can be achieved, with a slot filling factor of 85% being possible. The reduction in the slot area that becomes possible in consequence for a given winding cross-sectional area allows a better ratio of the area of the laminated core to the slot areas in the region between the slot base radius and the slot slit radius. Such a configuration also assists the magnetic flux in the laminated core. At the same time, the laminated core can be constructed to be shorter on the yoke side of the slots, that is to say, the stator yoke, with respect to the longitudinal axes of the slots, thus, making it possible to save laminate material. The configuration also results in better scatter conditions for the magnetic flux and, in consequence, the proportion of the iron area of a slot pitch increases.

In accordance with another feature of the invention, the winding wire has a radius and the slots have a slot base radius larger, preferably, at least double, the radius of the winding wire. In particular, the slot base radius is at least five times larger than the radius of the winding wire.

In accordance with a further feature of the invention, the slots have a yoke side and corners at the yoke side, the slots have regions at the corners, and the regions are curved with a radius equal to a slot base radius, are separated from one another in the slots by a slot base length, and are each larger than the slot base length.

In accordance with an added feature of the invention, the slots have tooth head webs and each of the tooth head webs has a height at least equal to the diameter of the winding wire.

In accordance with a concomitant feature of the invention, the slots each have a slot length and a slot width, the core has teeth each having a tooth width, and the tooth width is at least 80% of the slot width. Preferably, the slot width is measured at a center of the slot length.

A further advantage of the invention is that the slot base radius and the tooth width of the teeth that project out of the laminated core into the region of the slots can be enlarged in comparison to the slot areas. Such a measure also results in a reduction in the magnetic potential drops in the iron and iron losses because the magnetic flux is improved.

The height of the webs that form the openings of the slots is matched to the height of the insertion lips of the insertion tool. The windings, which slide out of the insertion lip of the tool at the side into the slot, must in the process not become attached to the web, or be damaged by it. However, at the same time, the webs are sufficiently high that no magnetic saturation occurs in the region of the teeth of the laminated core. On the other hand, they are sufficiently small in comparison to the slit opening of the slot to keep the tooth scatter influences small.

With regard to the conductive cross-section of the winding wire in the region of the slot, it can be stated that its heating governs the cross-section, and that maximum reactances governed by field attenuation determine the number of turns. The cross-section of the wire, that is to say, including a duplicated insulation layer or a stove-enameled layer as well as the tolerances that are correlated with these variables, define the total winding area. If the laminated core is used for the internal rotor motor of a washing machine, the winding must, furthermore, be optimized to the high rotation speed adjustment range that is required for a washing machine. By way of example, a three-section series-connected winding is used for a washing machine.

The measures described above thus make it possible firstly to improve the magnetic flux, which leads to better induction of currents in the rotor while, and, secondly, to reduce the amount of noise produced due to the smaller width of the slit openings of the slots. The measures described above thus also contribute to further reducing the amount of noise produced in an internal rotor motor, in particular, for a washing machine drive motor.

Other features that are considered as characteristic for the invention are set forth in the appended claims.

Although the invention is illustrated and described herein as embodied in an electrical machine, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a plan view of a top face of a laminated core according to the invention without windings; and

FIG. 2 is a fragmentary plan view of a detail of the laminated core of FIG. 1, with a slot to be filled by a large number of winding wires (one shown in cross-section and greatly enlarged).

### DESCRIPTION OF THE PREFERRED EMBODIMENTS

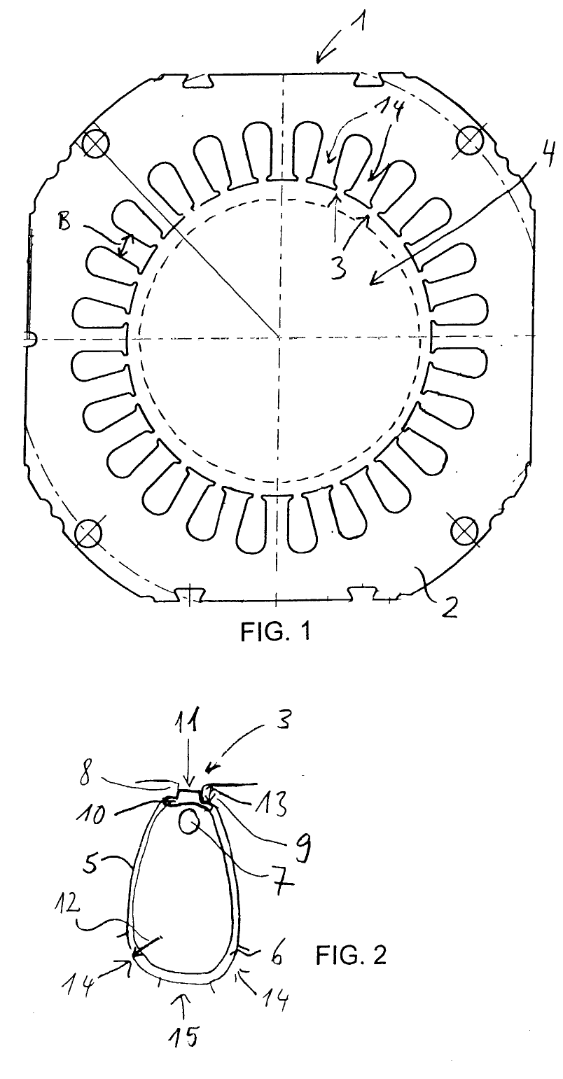

Referring now to the figures of the drawings in detail and first, particularly to FIG. 1 thereof, there is shown a laminated core 1 formed from a large number of laminates 2 in layers one above the other. The laminated core and, hence, each laminate 2 has slots 3 that are disposed around a central opening 4 in the laminated core 1. The opening 4 holds a rotor (shown only diagrammatically by a dashed line). Twenty four slots 3 are preferably disposed around the opening 4, with the rotor having 22 slots. Together with one winding or a number of windings, the laminated core 1 forms the stator of an electrical machine, for example, of a motor.

Each of the slots 3 is formed as is described in more detail in the following text with reference to FIG. 2. A slot lining 6 composed of an electrically insulating material is provided on an inner wall 5 of the slot 3. There-are sealing lips, which are associated with a winding tool, on the inside of the tooth head webs 8, 9 during the insertion of a winding wire 7, and these are removed after the insertion of the winding wire 7, and are replaced by a cover plate 10 composed of a material that is likewise insulating. This closes a slot slit opening 11, through which the slot 3 is opened to the opening 4 during the insertion of the winding wire 7. The tooth head webs 8, 9 have a height 13.

The slot slit opening 11 is of such a width that only the cross-section of a single winding wire 7 can be passed through it. Thus, the unobstructed width of the slot slit opening 11 is dimensioned such that, within the slot slit opening 11, the insertion lips rest at the sides on the tooth head webs 8 and 9 while the winding wire 7 is being inserted. There is still a small amount of free space between the winding wire 7 and the slot 3 on the yoke side. Such a measure results in the magnetic flux having a more uniform profile in the laminate 2. The slot base radius 12 is preferably chosen such that the regions 14 are each longer than the slot base length 15.

The tooth head web 8 has a height that is likewise preferably a number of times the radius of the winding wire 7.

The width B (FIG. 1) of the teeth 14 in the laminated core 1 that separate the slots 3 from one another is at least 80% of the width of the slots 3. The width of the teeth 14 is preferably even greater, and is greater than the width of the slots 3.

We claim:

1. An electrical machine, comprising:
an internal rotor;
a laminated core surrounding said internal rotor;
said core having at least one winding wire forming a winding;
said winding wire having a diameter;
said core defining slots facing said internal rotor and through which said winding wire is passed a number of times;
said slots each having a slot slit opening; and
said slot slit opening facing said internal rotor and having an unobstructed width greater than said diameter of said winding wire but less than twice said diameter of said winding wire.

2. The machine according to claim 1, wherein:
said winding wire has a radius; and
said slots have a slot base radius at least double said radius of said winding wire.

3. The machine according to claim 1, wherein:
said winding wire has a radius; and
said slots have a slot base radius larger than said radius of said winding wire.

4. The machine according to claim 1, wherein:
said winding wire has a radius; and
said slots have a slot base radius at least five times larger than said radius of said winding wire.

5. The machine according to claim 1, wherein:
said slots have a yoke side and corners at said yoke side;
said slots have regions at said corners; and
said regions are:
curved with a slot base radius;
separated from one another in said slots by a slot base length; and
each larger than said slot base length.

6. The machine according to claim 2, wherein:
said slots have a yoke side and corners at said yoke side;
said slots have regions at said corners; and
said regions are:
curved with radius equal to said slot base radius;
separated from one another in said slots by a slot base length; and
each larger than said slot base length.

7. The machine according to claim 1, wherein:
said slots have tooth head webs; and
each of said tooth head webs has a height at least equal to said diameter of said winding wire.

8. The machine according to claim 2, wherein:
said slots have tooth head webs; and
each of said tooth head webs has a height at least equal to said diameter of said winding wire.

9. The machine according to claim 1, wherein:
said slots each have a slot length and a slot width;
said core has teeth each having a tooth width; and
said tooth width is at least 80% of said slot width.

10. The machine according to claim 1, wherein:
said slots each have a slot length and a slot width;
said core has teeth each having a tooth width; and
said tooth width is at least 80% of said slot width measured at a center of said slot length.

11. The machine according to claim 1, wherein said slot has a slot filling factor of at least 75%.

12. The machine according to claim 1, wherein said slot has a slot filling factor of at least 85%.

13. In an electrical machine having an internal rotor, a stator comprising.
a laminated core surrounding the internal rotor;
said core having at least one winding wire forming a winding;
said winding wire having a diameter;
said core defining slots facing said internal rotor and through which said winding wire is passed a number of times;
said slots each having a slot slit opening; and said slot slit opening facing said internal rotor and having an unobstructed width greater than said diameter of said winding wire but less than twice said diameter of said winding wire.
